(19) United States
(12) Patent Application Publication
(10) Pub. No.: US 2026/0166555 A1
(43) Pub. Date: Jun. 18, 2026

(54) JAW CRUSHER SYSTEMS, METHODS, AND APPARATUS

(71) Applicant: Superior Industries, Inc., Morris, MN (US)

(72) Inventors: Ed Sauser, Morris, MN (US); Grant Holmes, Morris, MN (US)

(21) Appl. No.: 19/531,915

(22) Filed: Feb. 6, 2026

Related U.S. Application Data
(63) Continuation of application No. 18/329,373, filed on Jun. 5, 2023, now Pat. No. 12,576,406.
(60) Provisional application No. 63/365,806, filed on Jun. 3, 2022.

(51) Int. Cl. B02C 1/02; B02C 1/04

(52) U.S. Cl. CPC B02C 1/025; B02C 1/04

(57) ABSTRACT

Systems, methods and apparatus are provided for crushing rock. In some embodiments a toggle feature of a jaw crusher is in tension during operation. In some embodiments a lower portion of the moveable jaw moves simultaneously moves closer to the stationary jaw and forward along a first direction. In some embodiments, said direction along which material moves between the moveable and stationary jaws is closer to horizontal than vertical.

### BACKGROUND

Aggregate is crushed by various types of crushers including jaw crushers.

### BRIEF DESCRIPTION OF THE DRAWINGS

FIG. 1 is a perspective view of an embodiment of a jaw crusher.

FIG. 2 is another perspective view of the jaw crusher of FIG. 1.

FIG. 3 is a side elevation view of the jaw crusher of FIG. 1.

FIG. 4 is a side elevation view of the jaw crusher of FIG. 1 with a sidewall not shown.

FIG. 5 schematically illustrates a path of a pivot point of the jaw crusher of FIG. 1.

FIG. 6 is a side elevation view of another embodiment of a jaw crusher with a sidewall not shown.

FIG. 7 is a side elevation view of another embodiment of a jaw crusher.

FIG. 8 is a side elevation view of another embodiment of a jaw crusher.

### DESCRIPTION

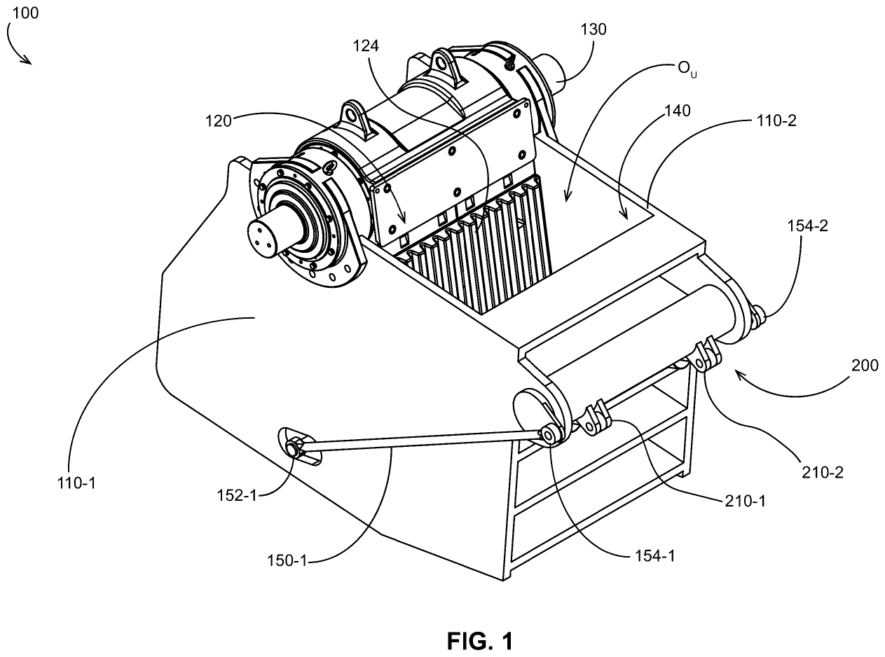

Referring to the drawings, wherein like reference numerals designate identical or corresponding parts throughout the several views, FIGS. 1-4 illustrate an embodiment of a jaw crusher 100. The jaw crusher 100 optionally comprises a moveable jaw 120 operably supported on an eccentric shaft 130. The moveable jaw 120 optionally comprises a removable jaw die 122 (e.g., optionally made of a wear-resistant material such as manganese and optionally having a corrugated surface facing the stationary jaw). The jaw crusher 100 optionally comprises a stationary jaw 140. The stationary jaw 140 optionally comprises a removable jaw die 144 (e.g., optionally made of a wear-resistant material such as manganese and optionally having a corrugated surface facing the moveable jaw). The stationary jaw 140 is optionally supported on spaced-apart sidewalls 110-1, 110-2. The eccentric shaft 130 is optionally rotatably supported on sidewalls 110-1, 110-2.

The sidewalls 110-1, 110-2 optionally cooperate with the moveable and stationary jaws 120, 140 to form both an upper opening O_{U} configured and disposed to receive aggregate material (e.g., rock, stone, gravel, sand, debris, etc.) and a lower opening O_{L} configured and disposed to release at least partially crushed aggregate material from the jaw crusher 100. The size of a gap G at the lower opening O_{L} optionally determines the size of material released from the lower opening; as the size of gap G varies during operation, a given size (e.g., minimum size) of gap G may be referred to in the art as the close-side setting. It should be appreciated that movement of the moveable jaw 120 about eccentric shaft (which is optionally driven by a motor such as an electric motor, not shown, which may drive the shaft via a flywheel, drive belt and/or other apparatus) includes movement toward and away from the stationary jaw 140 so as to crush material trapped between the moveable and stationary jaws.

In some embodiments, a link 150-1 is optionally pivotally coupled (e.g., at a first end thereof) to the moveable jaw 120. The link 150-1 is optionally pivotally coupled to the moveable jaw 120 via a crossbar 160 mounted to the moveable jaw 120 defining a pivot point 152-1. The link 150-1 is optionally pivotally coupled (e.g., at a second end thereof) to a support 255-1 (e.g., pin, bearing, shaft, etc.) defining a pivot point 154-1. Support 255-1 is optionally disposed on the opposite side of stationary jaw 140 relative to moveable jaw 120. Support 255-1 is optionally disposed outside of the space between sidewalls 110-1, 110-2. In some embodiments, supports 255 are optionally supported (e.g., welded, mounted with fasteners, etc.) with a breaking strength selected such that in the event the support 255 is broken to allow release of the movable jaw upon introduction of uncrushable material.

In some embodiments, a link 150-2 is optionally pivotally coupled (e.g., at a first end thereof) to the moveable jaw 120. The link 150-2 is optionally pivotally coupled to the moveable jaw 120 via crossbar 160 defining a pivot point 152-2. The link 150-2 is optionally pivotally coupled (e.g., at a second end thereof) to a support 255-2 defining a pivot point 154-2. Support 255-2 is optionally disposed on the opposite side of stationary jaw 140 relative to moveable jaw 120. Support 255-2 is optionally disposed outside of the space between sidewalls 110-1, 110-2.

Links 150-1,150-2 are optionally or substantially equal length. Links 150-1, 150-2 are optionally disposed outside of the sidewalls 110-1, 110-2. Crossbar 160 optionally extends through openings 112-1, 112-2 in the sidewalls 110-1, 110-2, respectively. Openings 112-1, 112-2 optionally are optionally configured to permit motion of the crossbar 160 as the moveable jaw 120 moves during operation.

It should be appreciated that for a given length of links 150-1, 150-2, the position of pivot point 154-1 (which is optionally coaxial with pivot point 154-2) determines the minimum gap G (e.g., close-side setting) during operation.

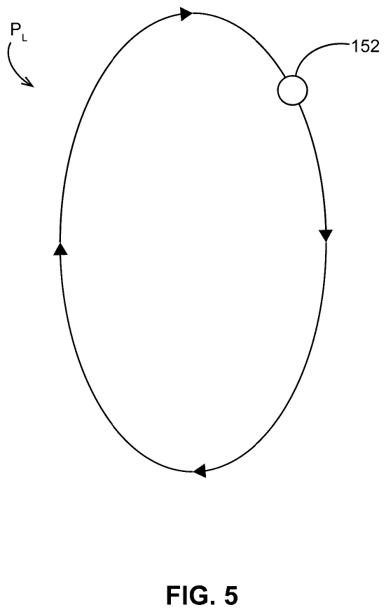

Referring to FIG. 5, during operation the pivot point 152-1 (which is optionally coaxial with pivot point 154-2) moves through a path P_{L}. It should be appreciated that pivot point 152-2 (and thus the lower portion of jaw die 132) moves downward as it moves toward the fixed jaw (e.g., moves downward through at least part of the inward or “crushing” portion of the path). It should be appreciated that the direction of rotation of eccentric shaft 130 is reversed (and/or alternately reversible) to reverse the direction of the path P_{L}.

It should be appreciated that crushing of material between the moveable and stationary jaws will place the links 150-1, 150-2 in tension. In the event that an uncrushable object (e.g., “tramp” material such as metal or excessively tough aggregate material) enters the jaw crusher 100, the links 150-1 and/or 150-2 optionally break to release the moveable jaw (e.g., such that more catastrophic damage to the jaw crusher 100 is avoided). A toughness and/or cross-sectional dimension of the links 150-1 and/or 150-2 are optionally selected in order to maintain integrity of the links 150 during normal crushing operations but to allow the links 150 to break upon introduction of uncrushable material. In some embodiments, the links 150 are extendable (e.g., incorporates a tension spring and/or hydraulic cylinder) to allow the links to extend upon introduction of uncrushable material.

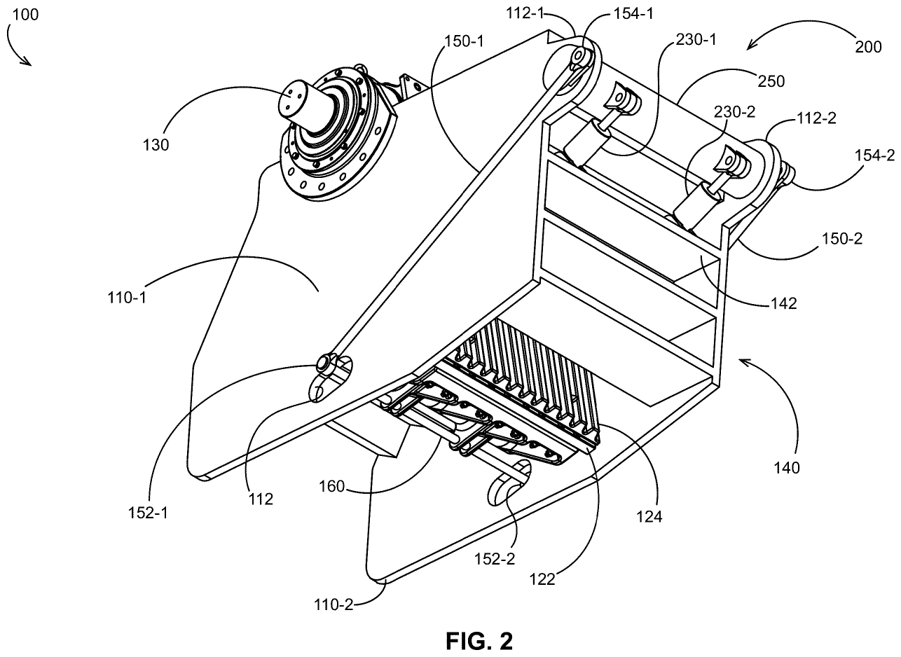

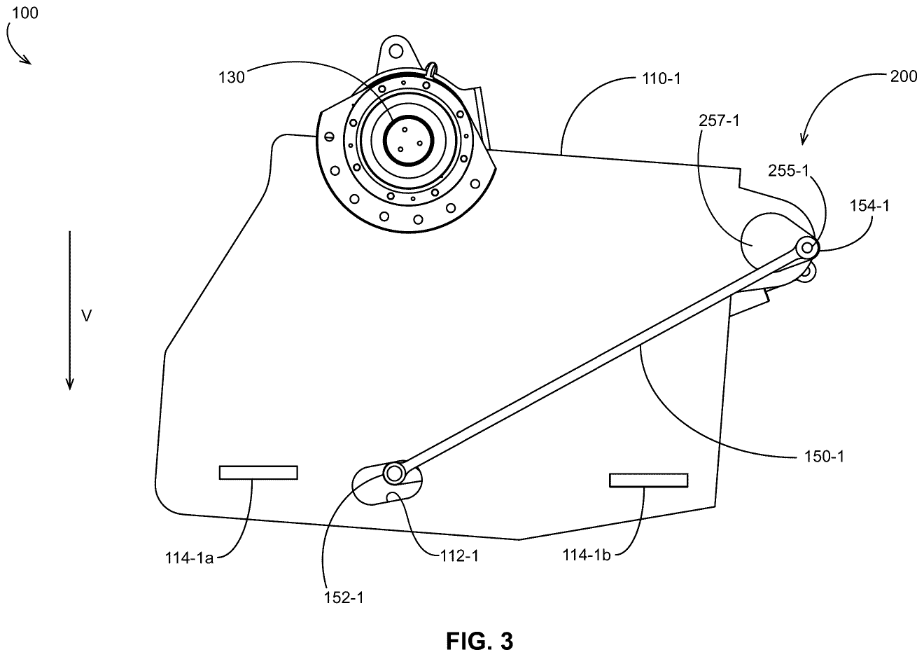

In some embodiments, the position of the pivot points 154-1, 154-2 is optionally adjustable (e.g., so as to modify the minimum gap G and/or path P_{L}). Referring to FIGS. 2 and 3, in some embodiments the jaw crusher 100 comprises a pivot adjustment assembly 200. The pivot adjustment assembly 200 optionally comprises plates 257 each supporting an associated support 255. The plates 257-1, 257-2 are optionally supported on opposing sides of a shaft 250. The shaft 250 is optionally rotatably supported on the sidewalls 110-1, 110-2 (e.g., in openings, bearings, etc. provided in the sidewalls 110). In various embodiments, the shaft 250 is selectively rotatable in order to modify a location of the pivot points 154. In the illustrated embodiment, one or more actuators 230 (e.g., hydraulic cylinders, electric length-adjustable actuators, etc.) are supported on the jaw crusher (e.g., on a support plate 142 supported between sidewalls 110, etc.) at first ends thereof and pivotally coupled to the shaft 250 at second ends thereof. It should be appreciated that alternate extension and retraction of each actuator 230 rotates the shaft 250 and thus modifies the location of pivot points 154, thus modifying the minimum gap G (e.g., close-side setting of the jaw crusher).

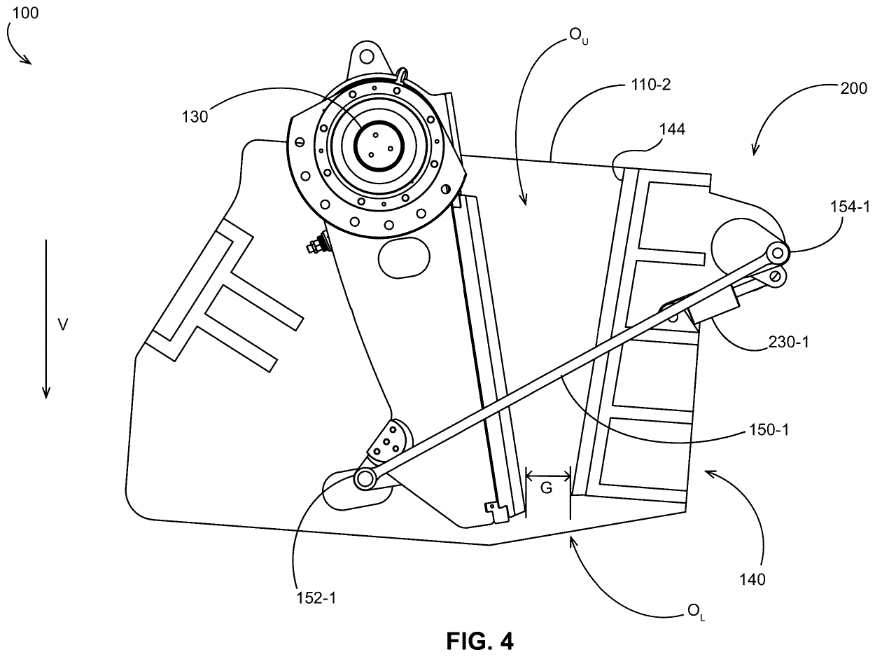

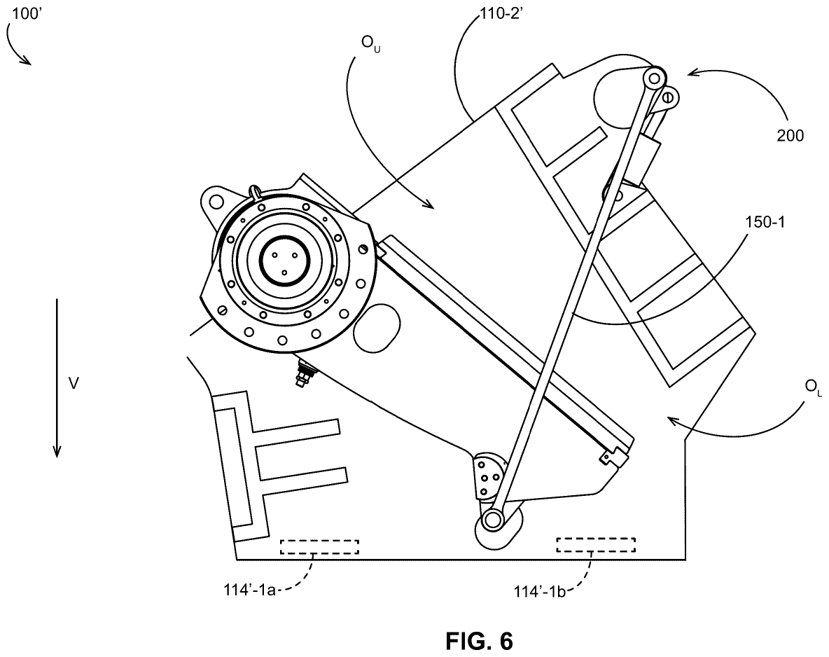

Referring to FIGS. 3 and 4, in some embodiments the jaw crusher 100 is disposed (e.g., on footings 114 provided on sidewalls 110) such that the direction of travel of material through the crusher (and/or the orientation of the moveable and/or stationary jaw dies) is closer to vertical than horizontal (e.g., less than 45 degrees from vertical, less than 40 degrees from vertical, less than 30 degrees from vertical, less than 20 degrees from vertical, less than 15 degrees from vertical, less than 10 degrees from vertical, etc.). Referring to FIG. 6, in some embodiments the jaw crusher is disposed (e.g., on footings 114′ provided on modified sidewalls 110′) such that the direction of travel of material through the crusher (and/or the orientation of the moveable and/or stationary jaw dies) is at 45 degrees from horizontal or closer to horizontal than vertical (e.g., less than 45 degrees from horizontal, less than 40 degrees from horizontal, less than 30 degrees from horizontal, less than 20 degrees from horizontal, less than 15 degrees from horizontal, less than 10 degrees from horizontal, etc.).

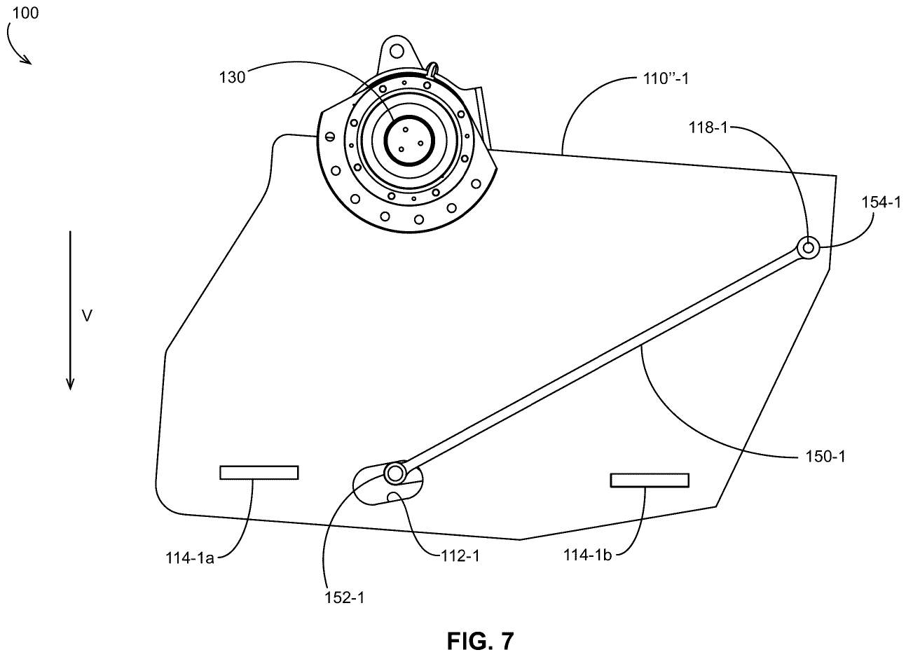

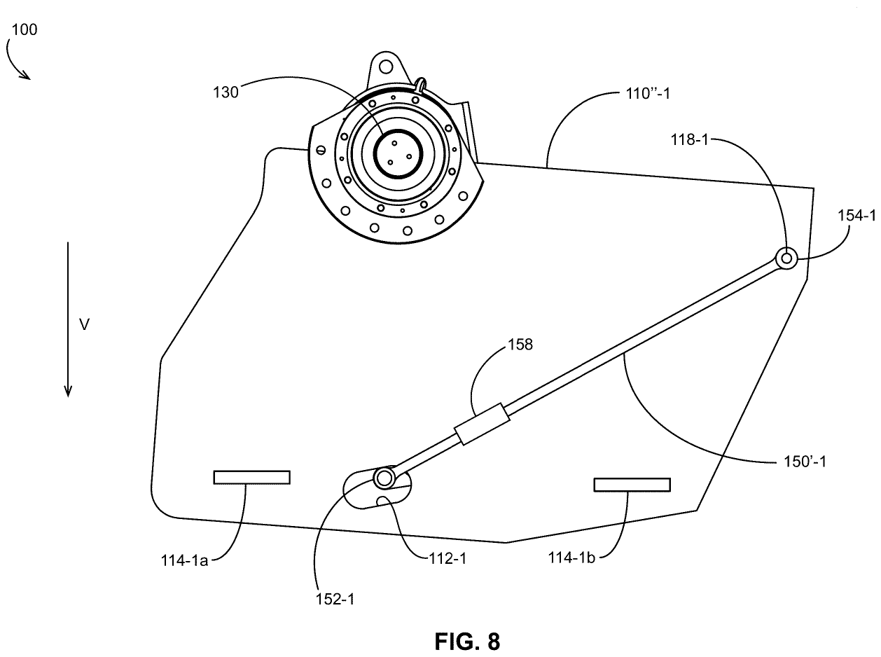

Referring to FIG. 7, in some embodiments the locations of pivot points 154 are not adjustable. In such embodiments an end of each link 150 is supported on a pin 118 supported by (e.g., supported on, mounted to, etc.) an associated sidewall 110″ (e.g., an external surface of the sidewall). In some embodiments, pins 118-1, 118-2 supported by the sidewalls 110″-1, 110″-2 are coaxial; in some embodiments, the pins 118 are not coaxial. Referring to FIG. 8, in some embodiments (e.g., embodiments with non-adjustable pivot points 154) the lengths the links 150′ are optionally adjustable. For example, each link 150′ optionally comprises a turnbuckle 158 configured to alternately extend or retract the link 150 (e.g., by rotating the turnbuckle 158).

In some embodiments, the jaw crusher 100 has one or more features or functionalities in common with U.S. Pat. No. 6,641,068, incorporated herein by reference. In some embodiments, the jaw crusher 100 has one or more features or functionalities in common with U.S. Pat. No. 9,662,655, incorporated herein by reference. In some embodiments, the crushing faces (e.g., faces of the jaw dies) are optionally curved or arched across the width of the jaw crusher. Additionally or alternatively, in some embodiments the crushing faces have a variety of profiles such as flat, slotted, corrugated etc. Additionally or alternatively, in some embodiments the crushing faces are be tapered (or more narrow width) along the sides thereof, e.g., to allow passage of fines along the sides of the crushing faces.

In various embodiments, the crusher embodiments described herein may be self-standing and/or may be incorporated in a plant having other equipment thereon (e.g., vibratory screens, vibratory feeders, crushers, impactors, hoppers, conveyors, etc.). The crusher embodiments and/or plant embodiments including such impactor embodiments may be stationary or portable (e.g., supported on skids, tracks, or wheels) according to various embodiments.

Ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A jaw crusher, comprising:
first and second sidewalls;
an eccentric shaft rotatably supported on said first and second sidewalls;
a stationary jaw supported between said first and second sidewalls, said stationary jaw having a stationary jaw pivot point;
a movable jaw supported on said eccentric shaft, said movable jaw having a movable jaw pivot point, wherein a crushing chamber is disposed between said movable jaw and said stationary jaw, said crushing chamber having an upper opening and a lower opening; and
at least a first link pivotally coupled to said movable jaw at said movable jaw pivot point, said first link being pivotally coupled to said stationary jaw at said stationary jaw pivot point, said first link extending past said crushing chamber, said first link defining a minimum gap at said lower opening between said stationary jaw and said movable jaw, said first link being in tension as material is crushed between said stationary jaw and said movable jaw.

2. The jaw crusher of claim 1, further comprising:
a second link connected to said movable jaw and said stationary jaw, said second link disposed on an opposing side of said jaw crusher from said first link, said second link extending past said crushing chamber.

3. The jaw crusher of claim 1, wherein said stationary jaw comprises a crushing face, said crushing face extending along a first direction, wherein said first direction is closer to horizontal than vertical.

4. A method for crushing aggregate material with a jaw crusher having a stationary jaw and a movable jaw, the method comprising:
coupling, by a link, said stationary jaw to said movable jaw;
moving aggregate material between the stationary jaw and the movable jaw along a first direction;
moving a lower portion of the movable jaw through a path, wherein said path includes a path portion in which said lower portion simultaneously moves closer to the stationary jaw and forward along said first direction, whereby a tension is applied to said link during at least a part of said path portion.

5. The method of claim 4, further comprising:
by said link, maintaining a minimum gap at a lower opening between said stationary jaw and said movable jaw; and
crushing material between the movable jaw and the stationary jaw such that said tension increases during such crushing action.

6. The method of claim 5, further comprising:
applying a compressive force to uncrushable material between the movable jaw and stationary jaw; and
breaking said link such that the minimum gap increases.

7. The method of claim 5, further comprising:
by moving a pivot point of said link, adjusting the minimum gap.

8. The method of claim 5, further comprising:
by adjusting a length of said link, adjusting the minimum gap.

9. The method of claim 4, wherein said path is shaped such that as said movable jaw approaches said stationary jaw, an angle between a face of said stationary jaw face and a crushing force vector increases.

10. A jaw crusher, comprising:
a frame;
a stationary jaw supported by the frame;
a movable jaw supported relative to the frame and configured to move with respect to the stationary jaw;
an eccentric shaft operably coupled to the movable jaw and configured to drive motion of the movable jaw;
a crushing chamber disposed between the stationary jaw and the movable jaw, the crushing chamber having an upper opening and a lower opening; and
a link pivotally coupled to the stationary jaw at a stationary jaw pivot point and pivotally coupled to the movable jaw at a movable jaw pivot point,
wherein the link is configured to be in tension during at least a portion of a crushing cycle, and
wherein a pivot geometry of the link establishes a minimum gap at the lower opening between the stationary jaw and the movable jaw.

11. The jaw crusher of claim 10, wherein the frame comprises first and second sidewalls, and wherein the eccentric shaft is rotatably supported on the first and second sidewalls.

12. The jaw crusher of claim 10, further comprising a second link coupled between the stationary jaw and the movable jaw, the second link being disposed on an opposing lateral side of the jaw crusher from the link.

13. The jaw crusher of claim 12, wherein the second link is pivotally coupled to the stationary jaw and pivotally coupled to the movable jaw.

14. The jaw crusher of claim 10, wherein the stationary jaw comprises a crushing face extending along a first direction, and wherein the first direction is closer to horizontal than vertical.

15. The jaw crusher of claim 10, wherein the link comprises an adjustable-length link assembly configured to change the minimum gap at the lower opening.

16. The jaw crusher of claim 10, wherein at least one of (i) the stationary jaw pivot point or (ii) the movable jaw pivot point is adjustable to change the minimum gap at the lower opening.

17. The jaw crusher of claim 10, wherein the link is configured to maintain the minimum gap at the lower opening during crushing of material between the stationary jaw and the movable jaw.

18. The jaw crusher of claim 10, wherein the link comprises a frangible portion configured to break in response to a compressive force applied to uncrushable material between the stationary jaw and the movable jaw.

19. The jaw crusher of claim 10, wherein said movable jaw includes a lower portion, wherein said jaw crusher is configured to move said lower portion through a path, wherein said path is shaped such that as said movable jaw approaches said stationary jaw, an angle between a face of said stationary jaw and a crushing force vector increases.

20. The jaw crusher of claim 10, wherein the movable jaw includes a lower portion configured to move through a path that includes a path portion in which the lower portion simultaneously moves closer to the stationary jaw and along a first direction, wherein the stationary jaw comprises a crushing face extending along the first direction.
